(19) United States
(12) Patent Application Publication
(10) Pub. No.: US 2005/0123275 A1
(43) Pub. Date: Jun. 9, 2005

(54) Audiovisual apparatus which simplified program recording reservation operation

(75) Inventor: Hiroyuki Horita, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/000,366

(22) Filed: Dec. 1, 2004

(30) Foreign Application Priority Data
Dec. 9, 2003 (JP) 2003-410002

(51) Int. Cl. H04N 5/76; G06F 3/00; G06F 13/00

(52) U.S. Cl. 386/83; 725/58

(57) ABSTRACT

The present invention can facilitate making a reservation of a recording of an audiovisual program without the need of inputting many conditions. A recording reservation operation is simplified by making it possible to set a standby time since the end of the reservation until the start of the recording. This can thereby facilitate increasing recording history data to which a user can refer to for a normal recording reservation, and contribute to simplifying the recording reservation operation.

### BACKGROUND OF THE INVENTION

1. Field of the Invention

The present invention relates to an audiovisual apparatus which simplified program recording reservation operation. More specifically, the present invention relates to an audiovisual apparatus capable of making a reservation of recording a program to be recorded after a predetermined time.

2. Description of the Related Art

A conventional apparatus, for example, a videocassette recorder (VCR) includes a function of making a reservation of recording an audiovisual program. In an operation of reserving a normal program recording, it is necessary to depress keys several times so as to input reservation conditions, which disadvantageously imposes a burden on the apparatus. To simplify the input of the reservation conditions, therefore, a history of the program recording is stored in a memory, for example, and input of new recording conditions can be omitted using the history. However, it is necessary to record audiovisual programs each by the reservation operation that imposes a burden on the apparatus, and stores a sufficient number of histories in the memory.

Japanese Patent Application Laid-Open (JP-A) No. 6-290510 discloses that a program history is stored as history data after recording or viewing an audiovisual program, and that if a present program is compared with the stored program data and coincident with the program data, a reservation according to the history can be automatically set. JP-A No. 10-106063 discloses that pattern data in which a recording start time is linked with a recording time is stored in a microcomputer, and that the pattern data is read during a reservation so as to simplify a reservation operation using the pattern data. There is known a recorder that includes a one-touch timer recording function. According to JP-A No. 10-106063, this function is such that when a user depresses a one-touch timer recording switch, a recording is started at the time of depression, and that a desired recording time is set according to the number of times of depressing the switch. This function can, therefore, simplify the recording operation.

These conventional techniques have, however, the following disadvantages. It is necessary to generate a recording pattern so as to simply performing an audiovisual recording, that is, a recording reservation. Namely, it is necessary to create a history of viewing or recording a program first. The one-touch timer recording function also makes it possible to start the recording operation at the time of depressing the switch, and to set and reserve a recording time. With this function, however, a reservation start time cannot be set and a recording reservation cannot be, therefore, executed satisfactorily.

### SUMMARY OF THE INVENTION

It is an object of the present invention to provide an audiovisual apparatus capable of simply making a reservation of recording an audiovisual program without the need of generating recording pattern data or a history as required for the conventional techniques.

According to one aspect of the present invention, there is provided an audiovisual apparatus comprising: means for determining a time at which a setting of a reservation of recording an audiovisual program is ended; and means for setting a standby time since the time at which the setting of the reservation is ended until the recording is started, wherein after passage of the standby time, the recording is started.

According to another aspect of the present invention, there is provided an audiovisual apparatus comprising: means for determining a time at which a setting of a reservation of recording an audiovisual program is ended; and means for setting a standby time since the time at which the setting of the reservation is ended until the recording is started, wherein after passage of the standby time, the recording is started, and the audiovisual apparatus further comprises means for storing history data on the recording executed by the reservation.

The present invention can, therefore, facilitate increasing recording history data to which a user should refer to during a recording reservation operation, and thereby considerably simplify the recording reservation operation.

### BRIEF DESCRIPTION OF THE DRAWINGS

FIG. 1 is a schematic diagram which depicts a transition of a menu screen for explaining an embodiment of the present invention;

FIG. 2 is a schematic diagram which depicts another menu screen for explaining the embodiment of the present invention;

FIG. 3 depicts a part of a remote control unit of an audiovisual apparatus according to the present invention;

FIG. 4 is a schematic diagram of yet another menu screen for explaining the embodiment of the present invention;

FIG. 5 is a flowchart which shows procedures for a recording reservation according to the present invention;

FIGS. 6A and 6B are schematic front views of examples of the audiovisual apparatus according to the present invention, i.e.,

FIG. 6A is a schematic front view of a video recorder as an example of the audiovisual apparatus according to the present invention;

FIG. 6B is a schematic front view of a television set as an example of the audiovisual apparatus according to the present invention;

FIGS. 7A to 7E are schematic diagrams which depict a transition of a menu screen according to another embodiment of the present invention;

FIG. 8 is a schematic diagram which depicts a history file menu screen for explaining the present invention;

FIG. 9 is a block diagram which depicts the audiovisual apparatus according to the present invention; and

FIG. 10 is a schematic diagram which depicts still another menu screen for explaining the embodiment of the present invention.

### DESCRIPTION OF THE PREFERRED EMBODIMENTS

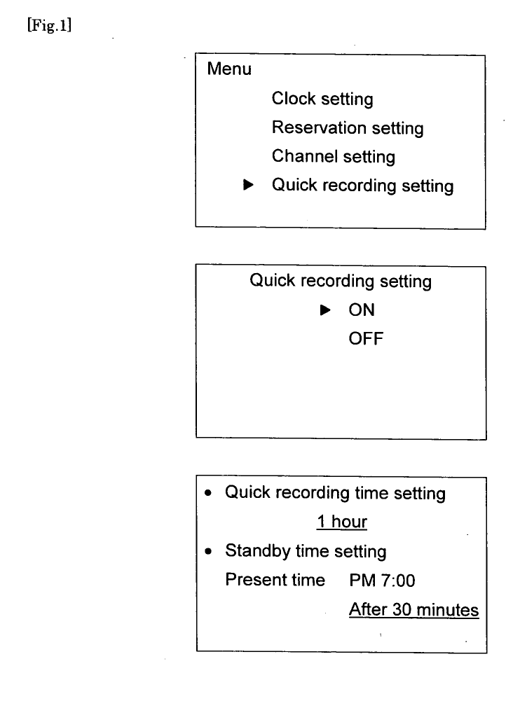

Exemplary embodiments of the present invention will be described hereinafter with reference to the accompanying drawings. When a user depresses a specific key switch (which key switch may also includes other functions), which key may be arranged near a power switch P on a remote control unit, shown in FIG. 3 while viewing an audiovisual program, a menu screen that displays a quick recording time setting, a standby time setting, and/or a present time appears at an appropriate position of an audiovisual apparatus as shown in FIG. 1. This specific key switch will be referred to as “a quick recording key switch Q”, and a recording reservation function executed by depression of this key switch Q will be referred to as “a quick recording reservation” hereinafter.

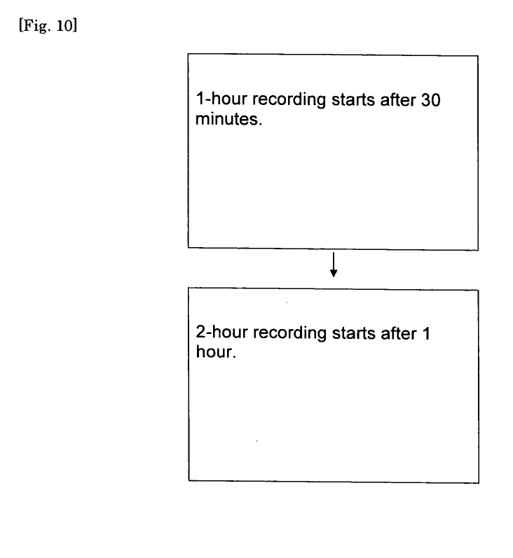

When the user depresses the quick recording key switch Q arranged on the remote control unit or the like once, the audiovisual apparatus turns into a quick recording reservation mode and a menu screen that displays “one-hour recording starts after 30 minutes” appears as shown in a lowest part of FIG. 1. In this case, when a certain time passes without depression of the quick recording key switch Q, a reservation is made that a one-hour recording starts after 30 minutes. If the user depresses the quick recording key switch Q one more time before passage of the certain time, 30 minutes' time is added to each time condition and a menu that displays “1.5-hour recording starts after one hour” is displayed. In this way, each time condition up to six hours may be set. Alternatively, the apparatus may be set so that after the user depresses the quick recording key switch Q to make the apparatus turn into the quick recording mode, and the user depresses the quick recording key switch Q one more time, then 30 minutes' time is added to a standby time and one hour's time is added to a recording time, as shown in FIG. 10. Further, the standby time and the recording time may be displayed in the form of sentences as shown in FIG. 10.

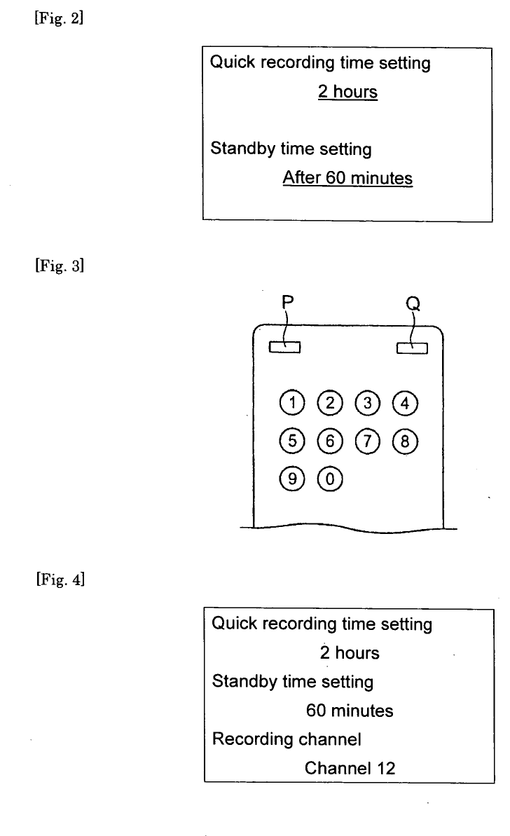

Many other methods are known as the method for setting the present time and the standby time using the key switch on the remote control unit. For example, the user depresses “6”, “0”, and “2” among ten keys after depressing the quick recording key switch Q, whereby a setting as displayed on the menu screen shown in FIG. 2 can be made. Namely, the setting can be made that “two-hour recording starts after 60 minutes”.

A recording channel and a recording mode selected when the user depresses the quick recording key switch Q may remain unchanged. Alternatively, the recording channel and the recording mode may be changed to the other channel and the other mode.

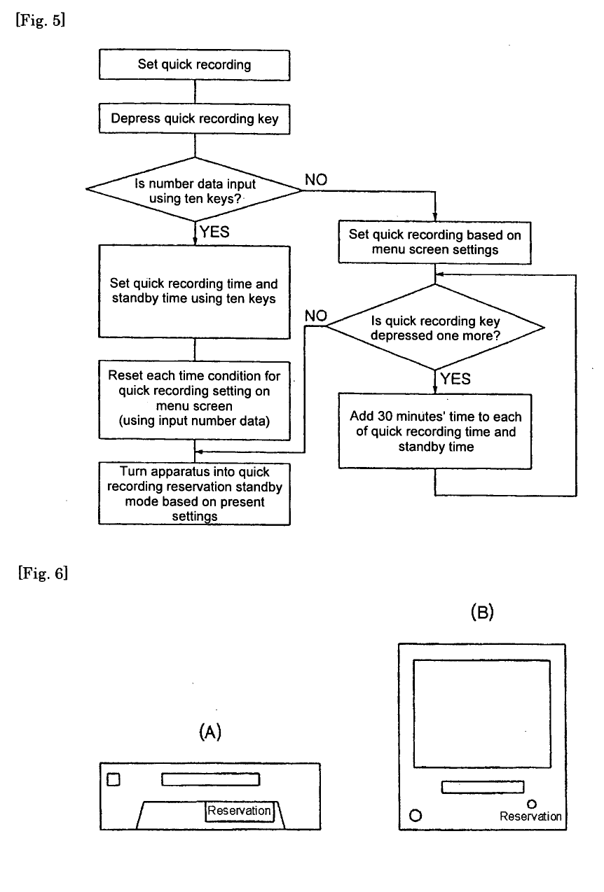

The setting of the recording time and the standby time and the setting of the recording channel can be made using either the quick recording key switch Q or the ten keys. FIG. 5 is a flowchart which shows procedures for the settings. The user can select whether to turn on or off a first quick recording setting. As shown in FIG. 1, the user selects the quick recording setting on an audiovisual apparatus setting menu and turns off the quick recording setting. In this case, even if the user depresses the quick recording key switch Q, this audiovisual apparatus does not accept the depression of the key switch Q. If the user turns on the quick recording setting, the quick recording setting is executed according to the procedures shown in FIG. 5. Next, it is detected whether number data is input using the ten keys. If number data is input using the ten keys, the recording time and the recording standby time are set using the ten keys as stated above. If no number data is input using the ten keys, it is detected whether the quick recording key switch Q is depressed. If the key switch Q is not depressed, the setting of “one-hour recording after 30 minutes” is made as a present setting, and the audiovisual apparatus turns into a reservation standby mode. While the apparatus is in this reservation standby mode, an internal counter starts counting the set standby time at the time, whereby a recording start time is set in a recording record file and the recording starts after passage of the standby time. Further, if it is detected that the quick recording key switch Q is depressed, the 30 minutes' time is added to each of the recording time and the standby time as stated above whenever the key switch Q is depressed once. If it is not detected that the quick recording key switch Q is depressed any more, a reservation is made based on the setting displayed at present and the apparatus turns into the reservation standby mode. Similarly to the above, the internal counter starts counting the set standby time at the present time, whereby the recording start time is set in the recording record file and the recording is started after passage of the standby time. As shown in FIGS. 6A or 6B, during the reservation standby mode, an indication that reservation is active is displayed on the audiovisual apparatus using a light emitting device (LED) or the like.

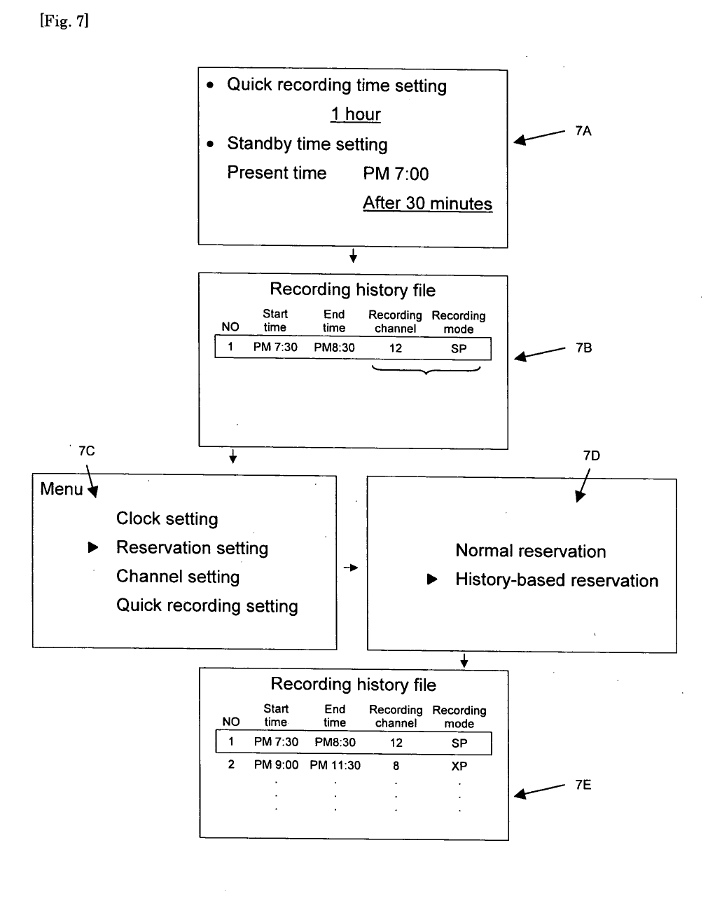

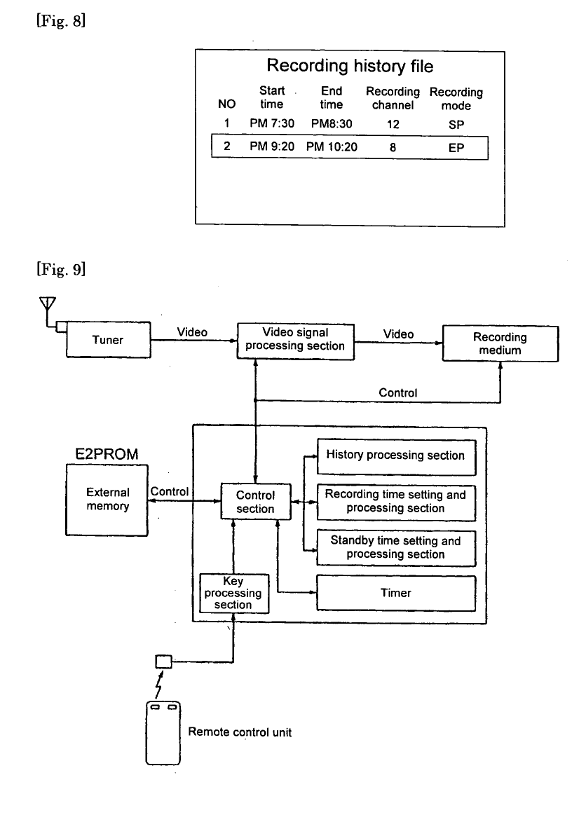

A recording history of the recording that has been executed according to the conditions set based on the quick recording reservation as stated above is stored in an external memory as a recording history file. Referring to FIGS. 7A to 7E, the recording history under the conditions, shown in FIG. 7A, for example, set based on the quick recording reservation, that is the conditions that the quick recording time is set at one hour and the standby time is set at 30 minutes, is stored in the external memory as shown in FIG. 7B. In the example of FIG. 7B, the recording channel and the recording mode are the same as those which have been selected when this quick recording reservation is made. Alternatively, the recording channel and the recording mode may be set when the quick recording reservation is made. As shown in FIGS. 7C to 7E, the recording history based on the quick recording reservation can be used to input the reservation conditions. This can, therefore, facilitate the recording reservation. As shown in FIG. 8, the recording history of the recording that has been executed according to the conditions set based on the one-touch timer recording function is also stored in the external memory as this history file.

As can be seen, not only the recording history based on the normal reservation but also the recording history based on the quick recording reservation and that based on the one-touch timer recording function are stored in the external memory. Therefore, the number of instances in which the reservation conditions can be input by referring to the history without the input by the user, i.e., reservation setting operator for setting the history-based reservation increase, thus facilitating the recording reservation.

FIG. 9 depicts the audiovisual apparatus for carrying out the present invention. A control section includes a history processing section, a recording time setting and processing section, and a standby time setting and processing section. The control section also includes the internal timer. This internal timer is used to count the standby time that has been set by the quick recording reservation. Further, the apparatus includes an external memory E2PROM controlled by the control section. This external memory stores various settings such as those for the recording time and the standby time made based on the recording history and the reservation function.

As stated so far, the apparatus and the method according to the present invention can facilitate making a reservation setting if, for example, the user goes out, the user has a sleep, the user wants to view a desired program but is unwilling to make a normal reservation recording setting since it takes too much time to do so, or the user knows only the start time. Even if program data such as electronic program guide (EPG) is not set or a clock is not set to correspond to the reservation setting, the reservation recording can be realized by employing the counting performed by the internal counter.

A person having ordinary skill in the art could readily understand that the present invention is applicable to various audiovisual apparatuses such as a television set, a VCR, a hard disk (HD) recorder, and a digital video cassette (DVC), for the reservation of recording audiovisual programs.

1. An audiovisual apparatus comprising:
means for determining a time at which a setting of a reservation of recording an audiovisual program is ended; and
means for setting a standby time since the time at which the setting of the reservation is ended until the recording is started, wherein
after passage of the standby time, the recording is started.

2. An audiovisual apparatus comprising:
means for determining a time at which a setting of a reservation of recording an audiovisual program is ended; and
means for setting a standby time since the time at which the setting of the reservation is ended until the recording is started, wherein
after passage of the standby time, the recording is started, and
the audiovisual apparatus further comprises means for storing history data on the recording executed by the reservation.
